(19) United States
(12) Patent Application Publication
(10) Pub. No.: US 2015/0355431 A1
(43) Pub. Date: Dec. 10, 2015

(54) Magnetic Coupling Mounts for Photonics

(71) Applicant: DataRay, Inc., Bella Vista, CA (US)

(72) Inventors: Steven E. Garvey, Bella Vista, CA (US); Melinda Dragone, Bella Vista, CA (US); Andrew D. MacGregor, Boulder, CO (US)

(73) Assignee: DATARAY, INC., Bella Vista, CA (US)

(21) Appl. No.: 14/301,257

(22) Filed: Jun. 10, 2014

(51) Int. Cl. G02B 7/02

(52) U.S. Cl. CPC G02B 7/022

(57) ABSTRACT

A mounting system for mounting an optical element to a supporting unit of an optical system that may include several optical elements in a predetermined alignment with respect to one another and with respect to an optical axis. A carrier holding an optical element in a known position and orientation with respect to the carrier is attached to a supporting unit in a selected location and position of rotation, with respect to an axis that may be the optical axis, by a plurality of magnetic elements, ones of which are carried in or affixed to the supporting unit in predetermined locations and orientations, and other ones of which are included in or affixed to the carrier in predetermined locations and orientations that result in mutual attraction between corresponding ones of the magnetic elements when the carrier is in a predetermined position with respect to the supporting unit. The numbers and locations of the magnets in the supporting unit may provide for a plurality of possible predetermined positions in which mutual magnetic attraction fastens the carrier to the supporting unit.

### BACKGROUND OF THE INVENTION

The present invention relates to mounting photonics components, and in particular relates to mounting an optical component reliably to a supporting unit, in a required location and orientation in an optical system.

In measuring beams, such as beams of coherent light, it may be necessary to attach optical elements such as filters to cameras or beam alignment measuring devices of various types.

Various apparatus has been used in the past for mounting optical elements, as shown, for example, in Melford U.S. Pat. No. 6,515,810. It is also known to utilize a magnetically coupled mounting carriage, as shown for example in a magnetically coupled removable mounting carriage available from Thorlabs, Inc.

Optical elements such as lenses and filters have long been attached to and removable from cameras and other components of optical systems acting as supporting units, by threaded mounts. Use of such mounts, however, may risk release of particulate debris from the threads, such as cracked anodization particles, dislodged dust, and skin particles released during the screwing process, that might interfere with desired observation of a light beam. Such mounts also may occupy more space than is desired and may be difficult to reach for adjustment in tight optical arrangements.

In some situations an optical element must be located so that it faces in a particular direction, that is, either toward or away from a camera or another component of an optical system.

In some situations an optical element of a system must be oriented at a particular angle of rotation about an optical axis.

Accordingly, what is desired is a mounting system for attaching an optical element of an optical system to a supporting unit, which may be another component of an optical system that is located in a predetermined position in an optical system. Ideally, such a mounting system can provide for an optical element to be mounted quickly and reliably in a required position on a supporting unit, can provide for such an optical element to be mounted in a selected one of at least two positions, and is relatively simple and inexpensive to manufacture and use.

### SUMMARY OF THE INVENTION

The present invention provides a mounting system, as defined by the claims that are a part of this disclosure, in which magnetic elements such as permanent magnets are contained in or attached to a supporting unit such as a housing for a component of an optical system, in a known, predetermined location and arrangement, and other magnetic elements are located and correspondingly arranged in a carrier holding an optical element to be used in the optical system concerned, and wherein the magnetic elements are oriented so as to be mutually attractive when the carrier is in a required location and orientation with respect to the supporting unit.

In an optical system that includes one embodiment of the mounting system disclosed herein a pair of permanent magnets may be located in a supporting unit that may be, for example, a housing for a component of the optical system. The magnets may be located diametrically opposite each other with respect to an optical axis of the optical system. Another pair of permanent magnets are mounted in or attached to a carrier for an optical element to be incorporated into the optical system and may be correspondingly located with respect to an optical axis of an optical element such as a lens, prism, filter, aperture, diaphragm, reflector, or graticule supported by and mounted in the carrier. Mutual attraction, between the permanent magnets in the supporting unit and those in the carrier, attract the carrier to the supporting element and mount the carrier on the supporting unit with the optical element held by the carrier in the required position.

In one embodiment of the mounting system there may be more than one such pair of permanent magnets mounted in the carrier and located so that the carrier can be attached to the supporting unit by mutual attraction of the respective magnets, to mount the carrier in any one of a plurality of desired positions and orientations with respect to the supporting unit and the optical axis of the optical system.

In one embodiment of the mounting system disclosed herein the carrier may have a pair of opposite sides and the magnets in the supporting element and the magnets in the carrier may be arranged so that the carrier may be attached to the supporting element only when a particular one of the sides of the carrier faces toward the supporting element.

The foregoing and other objectives and features of the invention will be more readily understood upon consideration of the following detailed description of the invention taken in conjunction with the accompanying drawings.

### BRIEF DESCRIPTION OF THE DRAWINGS

FIG. 1 is an isometric view of an optical device, such as a digital camera, for use as a part of an optical system and which serves as a supporting unit, shown with a carrier for an optical element attached to the supporting unit.

FIG. 2 is a simplified front elevational view of the camera shown in FIG. 1.

FIG. 3 is an exploded isometric view showing the camera shown in FIG. 1, together with a pair of carriers such as the one shown in FIG. 1.

FIG. 4 is an exploded isometric view showing the camera shown in FIG. 1 together with an optical element including a threaded base for attaching the optical element to the camera shown in FIGS. 1-3.

FIG. 5 is a sectional view taken along line 5-5 of FIG. 2, showing the camera and the carrier shown in FIG. 1, as well as a pair of additional carriers and included optical elements, shown spaced apart from the carrier mounted on the camera.

FIG. 6 is an exploded isometric view of a carrier such as one of those shown in FIGS. 1-5, together with a filter to be held in the carrier.

FIG. 7 is an exploded isometric view of the camera shown in FIG. 1, taken from the rear side thereof and showing the locations of permanent magnets mounted in a rear portion of the housing thereof.

FIG. 8 is a rear elevational view of the camera shown in FIG. 2.

FIG. 9 is a somewhat schematic representation of one of the carriers shown in FIGS. 1-6, showing representative positions for a pair of magnets carried therein, as seen from a first side of the carrier.

FIG. 10 is a somewhat schematic representation of the carrier shown in FIG. 9, taken from the opposite side of the carrier, and showing the pair of magnets carried therein.

FIGS. 11 and 12 are somewhat schematic representations similar to FIGS. 9 and 10 showing opposite sides of a carrier including four magnets and in which an optical element such as a planar filter is housed and supported at a small inclination with respect to the carrier.

FIGS. 13 and 14 are views similar to FIGS. 11 and 12, showing opposite sides of a carrier in which an optical element is housed and supported at a small inclination oriented at a different rotational angle with respect to the locations of four magnets included in the carrier.

FIGS. 15 and 16 are elevational views of, respectively, the front and rear of a supporting unit on which carriers for optical elements of an optical system can be mounted using the mounting system disclosed herein.

FIGS. 17 and 18 are somewhat schematic representations of a carrier similar to that shown in FIGS. 1, 3, 5, and 6, in which there are eight permanent magnets located in an arrangement in accordance with an embodiment of the apparatus disclosed herein, as seen, respectively, from the opposite front and rear sides of the carrier.

FIGS. 19 and 20 are somewhat schematic representations of another carrier generally similar to that shown in FIGS. 1, 3, 5, and 6, but in which there are 32 permanent magnets in another arrangement in accordance with an embodiment of the apparatus disclosed herein, as seen, respectively, from the opposite front and rear sides of the carrier.

FIGS. 21 and 22 are somewhat schematic representations of another carrier similar to that shown in FIGS. 1, 3, 5, and 6, in which there are twelve permanent magnets arranged in parallel polarity in accordance with another embodiment of the apparatus disclosed herein, as seen, respectively, from the opposite front and rear sides of the carrier.

FIGS. 23 and 24 are somewhat schematic representations of another carrier similar to that shown in FIGS. 19 and 20, in which there are 32 permanent magnets arranged in parallel polarity in accordance with another embodiment of the apparatus disclosed herein, as seen, respectively, from the opposite front and rear sides of the carrier.

### DETAILED DESCRIPTION OF PREFERRED EMBODIMENTS

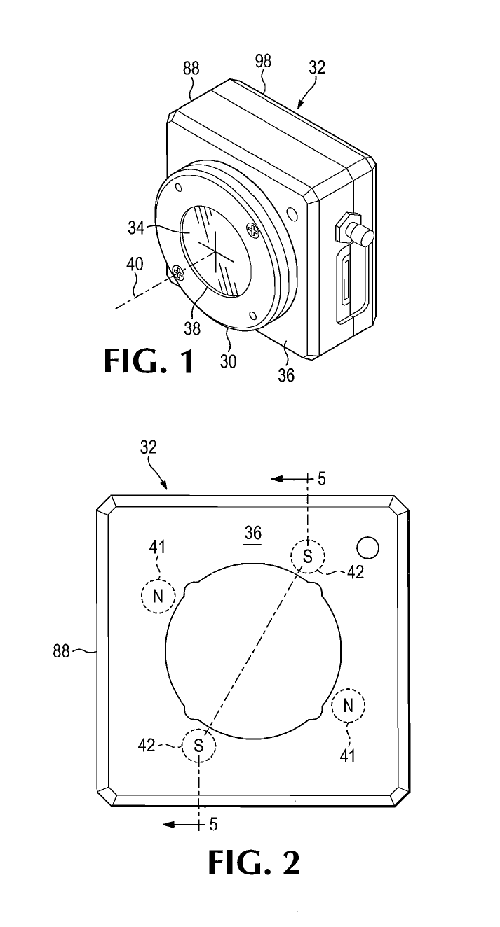

Referring now to the drawings which form a part of the disclosure herein, in FIG. 1 a carrier 30 is shown attached to a supporting unit 32 through the use of a mounting system as disclosed herein. The carrier 30 houses and supports an optical element 34 such as a filter, and the supporting unit 32 may, as shown, be a beam profiling camera. The mounting system described herein holds the carrier 30 tightly against a front face 36 of the body of the camera 32 in a selected location on the front face 36. For example, as shown in FIG. 1, the carrier 30 is attached to the camera 32 and located so that a central opening 38 defined by the carrier 30 is centered about an optical axis 40 of an optical system of which the camera 32 is a part.

Additionally, the mounting system holds the carrier 30 against the front face 36 in a desired one of a plurality of available predetermined positions of rotation about the optical axis 40, as will be explained in greater detail presently.

At least one pair, and as shown in FIG. 2, two pairs of permanent magnets 41 and 42 may be mounted within the front of the body of the camera 32 in respective locations where the permanent magnets of each pair are located in diametric opposition to each other, centered on and located symmetrically about the optical axis 40.

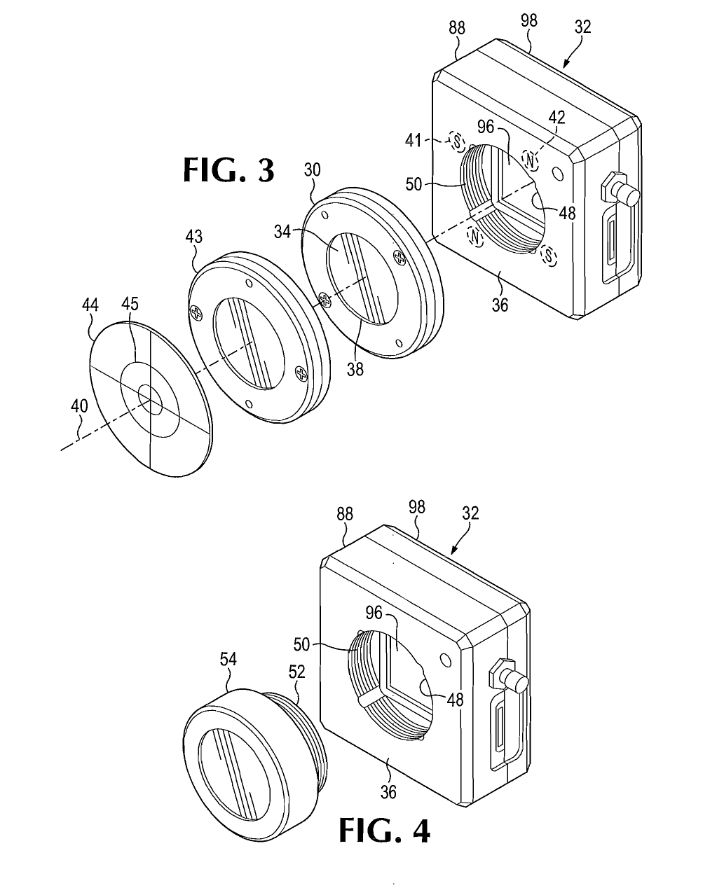

As shown in exploded view in FIG. 3, the mounting system is not limited to mounting the single carrier 30 to a supporting unit such as the camera 32, as an additional similar carrier 43 can be attached to the carrier 30, and an additional item such as a cover 14 formed of sheet permanent magnet material can also be attached to the carrier 43 or to the carrier 30. The cover 44 is held magnetically in place on a face of the carrier 30 or 43, and may include a target 45 that may be useful in aligning an optical system.

An element of an optical system, such as the camera 32, that is designed to be used as a supporting unit of the mounting system disclosed herein is not precluded from incorporating a conventional mount for optical elements. Thus, as shown in FIGS. 3 and 4, the opening 48 in the front face 36 of the body of the camera 32 is aligned with the optical axis 40 and includes internal threads 50 of a conventional threaded mount system in which a threaded male mount part 52 of an optical element 54, which may be a lens or filter, etc., can be matingly received.

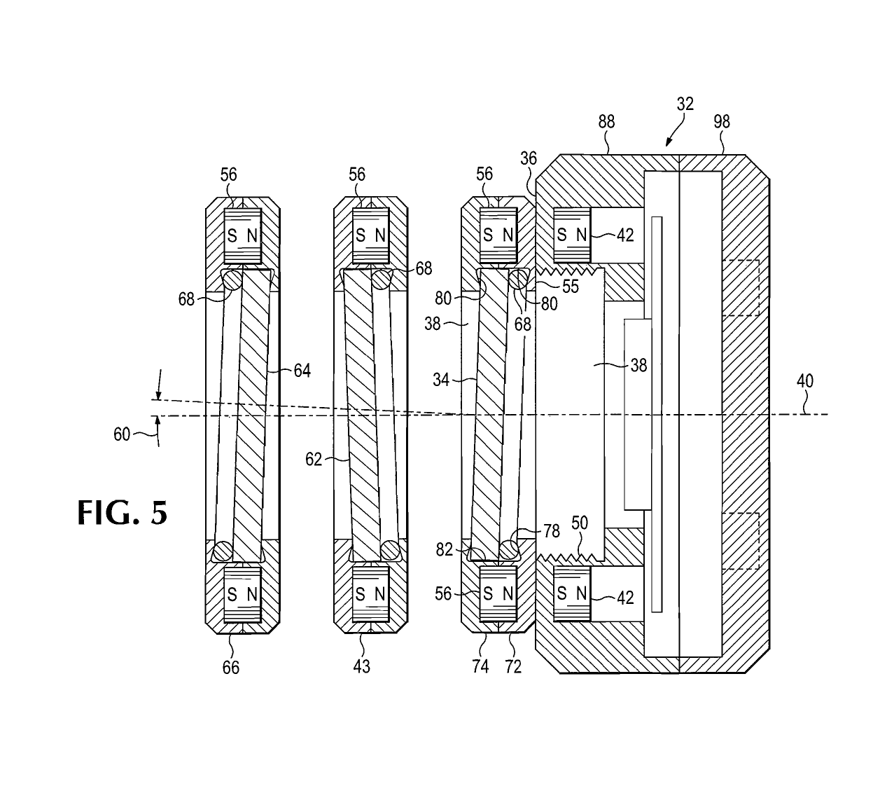

Referring also to FIG. 5, it may be seen that the carrier 30 is attached to the front face 36 of the camera 32 with a flat rear face 55 of the carrier 30 held closely against the front face 36 of the camera 32. Respective magnets 41 and 42 located in cavities defined in the front body part of the camera 32 and similar magnets 56 and 58 located at respective positions within the carrier 30 that correspond with the positions of the magnets 41 and 42 in a supporting unit such as the camera 32. The respective magnets mutually attract each other and urge the carrier 30 into a position in contact with the front face 36 where the magnets are aligned with each other as closely as possible. This mutual attraction between at least two pairs of magnets urges the carrier 30 into a position along the front face 36 of the camera body in which the optical element 34 held by the carrier 30 is located in a predetermined, desired, position with respect to the optical axis 40. The mutual attraction between corresponding magnets also urges the carrier into a desired position of rotation about the optical axis 40, as determined by the location of each of the magnets 56 and 58 within the carrier 30.

It can be seen in FIG. 5, for example, that the carrier 30 holds the optical element 34 so that a line normal to one of the parallel faces, or a central plane, of the optical element 34 defines a small pointing angle 60, in the range of, for example less than 3°, with respect to the optical axis. Such an inclination of an optical element may be desired, for example, to reduce or eliminate the possibility of reflections interfering with transmission of light along the optical axis 40. In an optical system in which there are additional optical elements, such as additional filters 62 and 64 housed in the carriers 43 and 66 shown in FIG. 5, the optical elements in those carriers may be held in respective positions with respect to the optical axis 40 in which those optical elements are not parallel with the optical element 34 in the carrier 30.

Additionally, it may be seen in FIG. 5 that the carrier 66, furthest from the front face 36 of the camera body 32, is oriented oppositely, as may be determined by the opposite location of the O-ring 68 with respect to the optical element 64 in the carrier 66 by comparison with the location of the O-ring 68 with respect to the optical element 62 in the carrier 43. Some optical elements may have coatings (not shown) on one side or the other of the optical element that may make the orientation of the optical element, either toward or away from a light source included in an optical arrangement, a factor to be considered.

Yet a further consideration is the position of rotation of an optical element about the optical axis 40, which may also need to be chosen in order to avoid having any surfaces of an optical element parallel with any surfaces of another optical element held in another carrier or otherwise included in the optical system in which a supporting unit such as the optical device 32 and the carriers 30, 43, and 66 are included.

While the optical elements shown in FIGS. 4 and 5 are shown as planar and with parallel surfaces, the optical element held in a carrier 30 may, as mentioned above, be any of several different kinds of optical elements such as lenses, prisms, filters, devices defining apertures or slits, devices intended to reflect light of certain wavelengths, or devices defining gratings or graticules, any of which could be mounted in and held in place on an optical device or other supporting unit 32 by use of the mounting system disclosed herein.

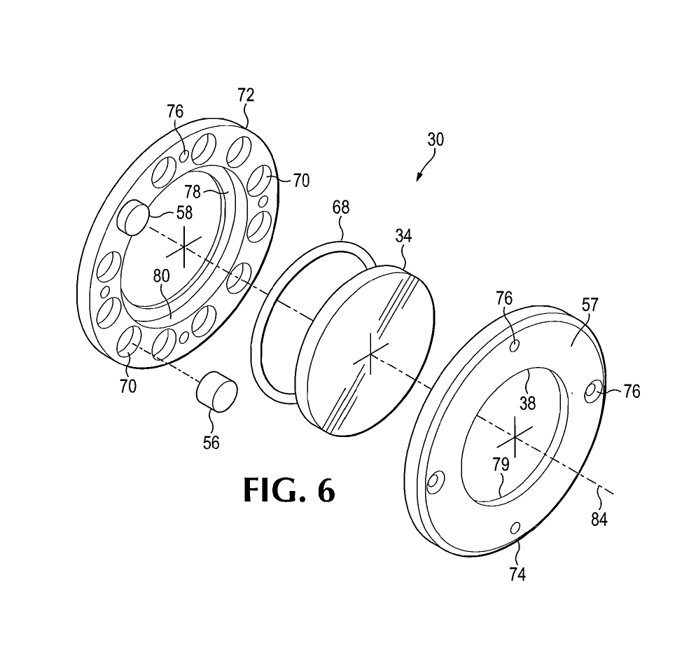

As shown in FIG. 6, the carrier 30 is designed to house an optical element 34 such as a planar filter and to carry small cylindrical permanent magnets 56 and 58 in corresponding cavities 70 defined cooperatively by two similar halves 72 and 74 of the carrier body, which is of a non-magnetic material such as aluminum alloy. An O-ring 68 may be located within the carrier 30 where it will be compressed slightly by fastening the two halves 72 and 74 of the carrier 30 closely together by using fasteners such as flathead screws (not shown) in respective bores 76. A pair of flanges 78 and 79 are directed radially inward from respective cylindrical walls 80 and 81 and cooperatively define a receptacle for the optical element 31 and the O-ring 68, or another compressible article such as a thin strip of metal foil, that may be compressed to keep the filter or other optical element 34 snugly and accurately located between the two halves 72 and 74 of the carrier. As may be seen best in FIG. 5, the flanges 78 and 79 have annular surfaces that are parallel with and face toward each other but that are inclined with respect to the parallel, flat, outer faces 55 and 57 of the two halves 72 and 74 of the carrier 30. This inclination defines the pointing angle 60 mentioned above. A line perpendicular to the plane of either of the flanges 78 and 79 thus intersects a central axis 84 of the carrier 30, oriented perpendicular to the outer faces 55 and 57, to define a plane oriented at a particular angle of rotation about the central axis 84 of the carrier 30 that may be referred to as an orientation of inclination.

As shown in FIG. 6, there may be twelve shallow cylindrical cavities 70 in each of the halves 72 and 74 of the carrier 30, each located so as to be aligned with another when the halves 72 and 74 of the carrier 30 are mated and fastened together. The magnets 56 and 58 are generally cylindrical and preferably have a length great enough so that each magnet extends into the corresponding cavity 70 in both of the halves 72 and 74 of the carrier 30. Up to twelve magnets 56 or 58 may be contained within the carrier 30 as shown and may thus be made available to attract a correspondingly located magnet 41 or 42 in a supporting unit 32. The magnets 56 and 58 are preferably magnetized along a longitudinal axis of each cylindrical magnet, with their north and south poles located at the opposite ends of the magnets. The magnets may, for example, be strong rare earth magnets which are commonly available, and may have a length of about 0.120″ and a diameter of about 0.172″. The size and strength of the magnets are chosen to be sufficient to securely support a carrier 30 or more than one such carrier in a stacked or tandem arrangement.

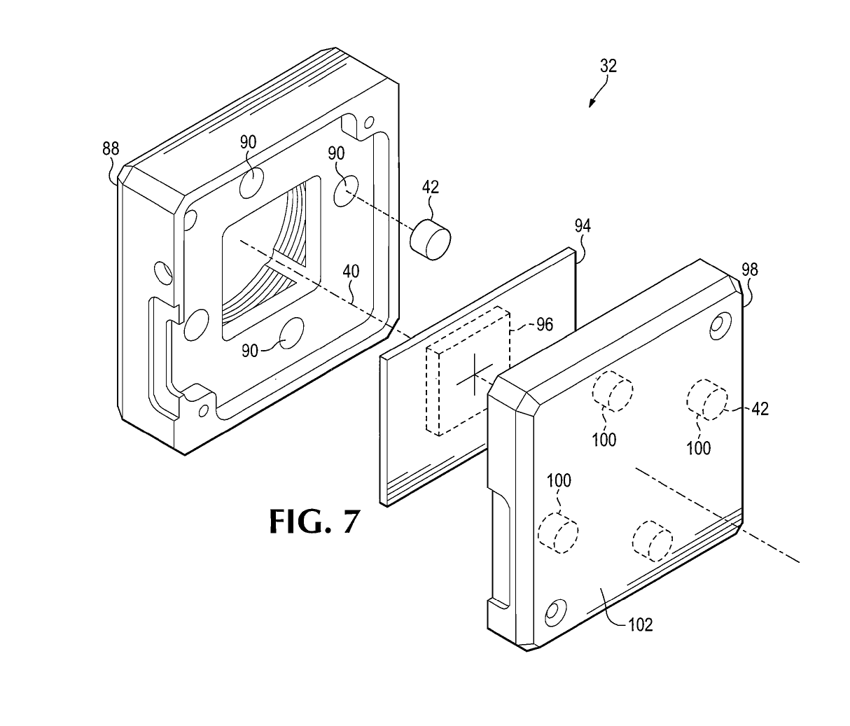

As may be seen in FIGS. 2 and 7, where the supporting unit 32 is, for example, a beam profiling camera, a front body part 88 of the camera 32 defines four cavities 90 located symmetrically and equally spaced apart from one another about the optical axis 40 of the optical system of which the camera 32 is a component. A permanent magnet 41 or 42 similar to the permanent magnets 56 and 58 shown and described with respect to FIG. 5 is located within each of those cavities 90, where it may be retained by a suitable adhesive material or a mechanical device such as a spring clip located in the cavity adjacent to the magnet 41 or 42. Each magnet has an axis of polarity parallel with the central axis of its cylindrical shape and each magnet 41 and 42 is installed in its respective cavity 90 or 100 with its pole nearest the front face 36 or rear face 102 of the camera 32 identified as shown in FIGS. 2 and 7. As indicated in FIG. 2, the poles of the magnets 41 are oriented oppositely to those of the magnets 42.

It will be understood that with twelve magnets, or six pairs, located in the carrier 30 as shown in FIG. 6, depending on the orientation of the polarity of each magnet 56 or 58 is as it is positioned within the respective cavity 70, there may be as many as twelve positions of rotation of the carrier about the optical axis 40 in which there can be mutual attraction between magnets in the carrier and correspondingly located, opposite polarity magnets in the supporting member 32.

As may be seen in FIG. 7 space is also available within the front part 88 of the body of the camera 32 for a circuit board 94 and a sensor 96 carried on the circuit board 94 and located in a desired position with respect to the central opening 38 in the front of the camera body 32. A rear body portion 98 of the camera 32 may be fastened to the front portion by screws (not shown) or other suitable fasteners.

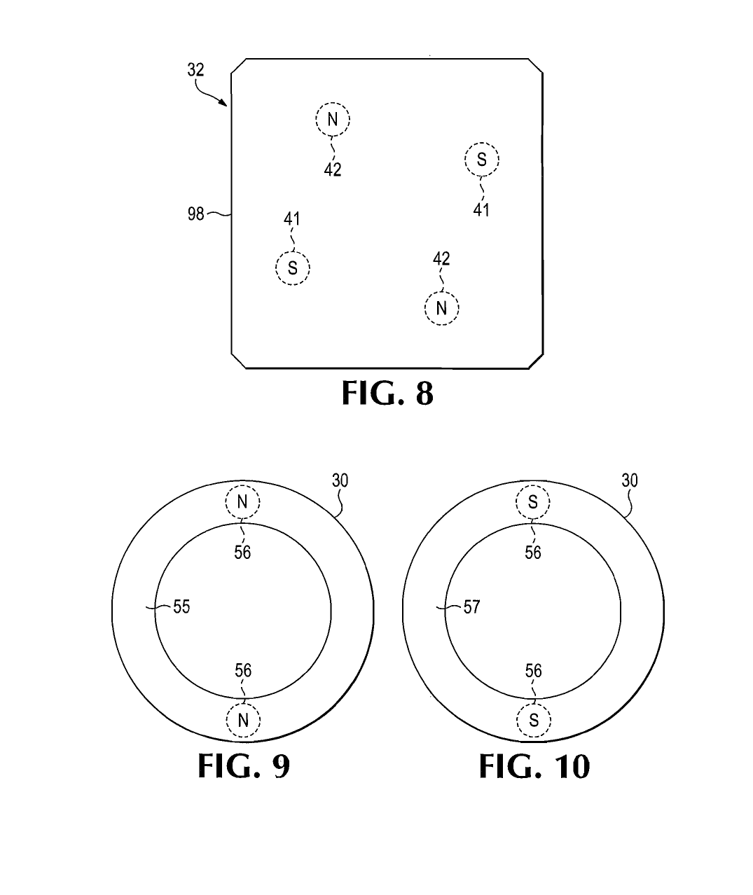

The rear body portion 98 may also define four cavities 100 for receiving similar magnets 41 and 42. The cavities 100, shown in FIGS. 7 and 8, may be aligned with the locations of the cavities 90 in the front body part 88 of the camera 32, in a pattern similar to that in which the magnets 41 and 42 are located in the front body part 88. A carrier 30 may then, if desired, be removed from the front of the camera 32 and mounted on the back face 102 of the supporting unit 32 without having to rotate it, either about the central axis of the carrier 30 or about an axis located generally in the plane of the carrier 30, when the optical element carried in the carrier 30 is not in use as a part of an optical system.

The carrier 30 may be provided with, for example, twelve cavities 70 for magnets, as shown in FIG. 6, but there may be fewer magnets 56 and 58 actually installed, as illustrated schematically in FIGS. 9-14, for example.

When a carrier such as the carrier 30 is held near or even in contact with the front face 36 of the supporting member magnetic attraction will cause the carrier to slide into the closest one of the several predetermined positions of rotation and into the required location in horizontal or vertical translation (as shown in FIGS. 1-4) with respect to the supporting unit 32 to place the optical element held in the carrier as intended. The receiving face of the supporting unit 32, such as the front face 36 of the camera, is preferably planar and smooth enough to allow the mating face of a carrier, such as the front face 55 or rear face 57 of the carrier 30, to slide along it easily, so that the carrier is readily moved along the supporting unit to the selected location and position of rotation.

In FIGS. 9 and 10, a carrier 30 is shown schematically with only two magnets 56 installed in diametrically opposite ones of the cavities 70. Both of the magnets 56 are installed with their poles oriented in the same direction. Thus the north poles of both magnets 56 are presented at the flat face 55 and will be attracted to the front face 36 of the camera 32 by the magnets 41 in the camera 32, located as shown in FIG. 2, in either of two possible positions separated by 180° of rotation of the carrier 30 with respect to the camera 32. By turning the carrier over, rotating it about an axis in the plane of the carrier 32, the opposite, south poles of the magnets 56 at the planar face 57 of the carrier 30 be brought to face toward the front face 36 of the camera 32, and the carrier 30 will be attracted to and held in position against the front face 36 by attraction of the magnets 56 to the magnets 42 in the supporting unit 32 or camera 32 in either of two positions of rotation separated from each other by 180°, but separated from the positions of rotation in which the face 55 is in contact with the front face 36 of the camera 32 by an angle of 90°.

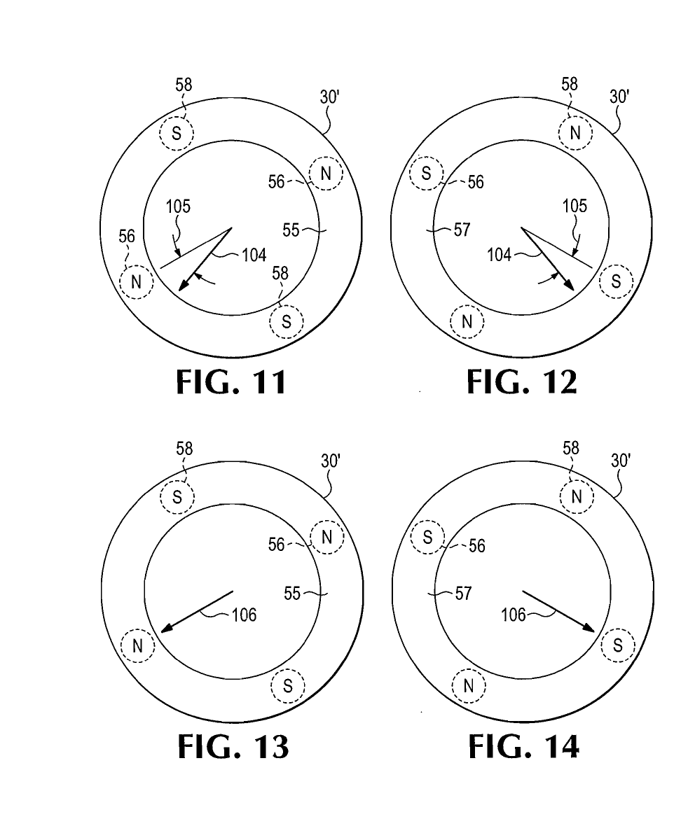

In FIGS. 11 and 12 a carrier 30′ shown schematically includes a pair of magnets 56 and a pair of magnets 58, with the magnets of each pair located diametrically opposite each other and with their poles oriented in the same direction as each other. The carrier 30′ can thus be attached to a supporting unit in the form of the camera 32 as shown in FIG. 2 in positions selected from the same number of possible positions as described above with respect to the carrier 30. In each of FIGS. 11 and 12, an arrow 104 indicates the direction in which the planes of the flanges 78 and 79 are inclined with respect to the planes of the planar outer faces 55 and 57 of the carrier 30′. It will be seen that arrow 104 is located at an angle 105 of several degrees, for example conveniently chosen as about 22.5 degrees, from a diameter of the carrier 30′ interconnecting the magnets 56.

In FIGS. 13 and 14, a carrier 30″ is similar to the carrier 30′ in most respects, but an arrow 106 indicates that the direction in which the planes of the flanges 78 and 79 are inclined with respect to the planes of the planar outer faces 55 and 57 is directly along a diameter interconnecting the magnets 56. Thus if a carrier 30″ is placed alongside a carrier 30′ the optical elements held respectively by the two carriers will be inclined in directions that differ from each other by the angle 105, or a multiple thereof, which may be important in order to avoid optical interference, such as that which might be caused by reflections, when light is transmitted along an optical axis passing through the optical elements held by the two carriers 30′ and 30″.

Indicia may be provided on the faces 55 and 57 of the carriers 30′ and 30″ to show the orientation 104 or 106 of the inclination of an optical element held in each of the carriers. Such indicia may, for example, be in the form of color coding, such as by coloring an entire carrier 30, 30′, or 30″ in a selected color to indicate the number or polarity pattern of magnets in the carrier, or the inclination orientation of the flanges 78 and 80. Color coding or other indicia may also be used to indicate the type of optical element held in a particular carrier 30, 30′, or 30″.

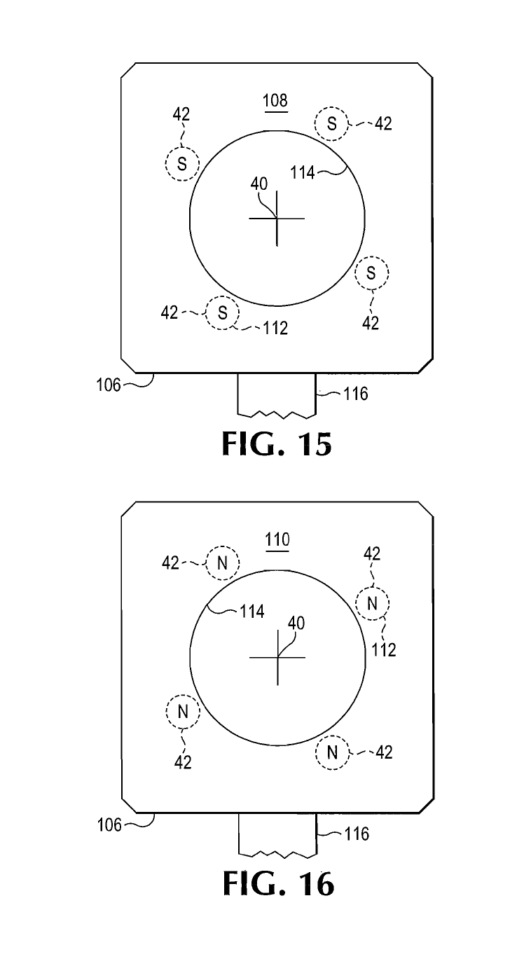

As shown in FIGS. 15 and 16, a supporting unit 106 not necessarily including an optical element such as a camera may be a generally planar sheet of a non-magnetic material such as aluminum or a suitable composite material having a planar front face 108 and a parallel planar rear face 110 and having a thickness between the front face and rear face great enough to include cavities 112 in which magnets 42 described above may be installed with their respective ends flush with or below the level of the front and rear faces 108 and 110. The cavities 112 may be located in an arrangement substantially similar to that of the cavities 90 in the front body part 88 of the camera 32. A central opening 114 may extend through the support unit 106 between the cavities 112, and the support unit 106 may be supported by a suitable base or post 116 or other support structure that can hold the supporting unit 106 in a desired position in an optical system. The four magnets 42, equally spaced apart in a square arrangement are, in the embodiment shown, all polarized in the same direction.

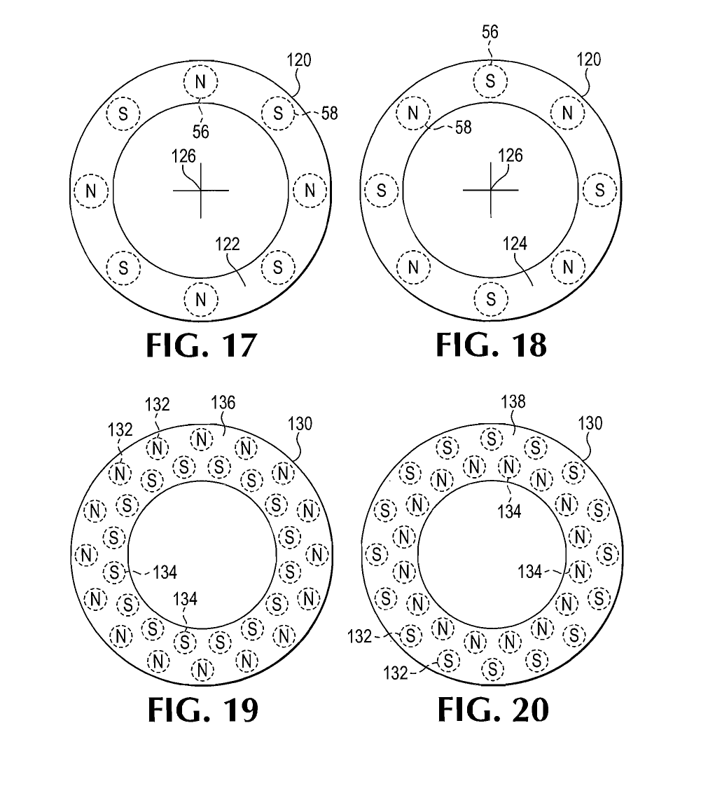

A carrier 120 for an optical element shown in FIGS. 17 and 18 is generally similar in construction to the carrier 30 shown, for example, in FIG. 6, but has cavities holding eight magnets 56 and 58 in respective locations spaced at equal 45° angles about the annular body of the carrier 120 and with their polarities arranged alternatingly. The front face 122 is shown in FIG. 17, while the opposite, rear, face 121 is shown in FIG. 18. The carrier 120 can be positioned and attached magnetically to the supporting unit 106 in any of four positions of rotation about a central axis 126 separated from one another by 90° with the front face 122 confronting the front face 108 of the supporting unit 106 or with the rear face 124 confronting the rear face 110 of the supporting unit 106. Similarly, the carrier 120 may be attached to the supporting unit 106 in any of four other positions of rotation about the central axis 126, offset by an angle of 45°, with the rear face 124 of the carrier 120 confronting the front face 108 of the supporting unit 106, or with the front face 122 of the carrier 120 confronting the rear face 110 of the supporting unit 106.

A carrier 130 shown in FIGS. 19 and 20 is also of generally similar construction to that of the carrier 30 shown in FIG. 6, but incorporates cavities for 32 smaller magnets 132 and 134, arranged in concentric circles. Sixteen magnets 132 are shown spaced apart from one another by equal angles of 11.25° in an outer circle and sixteen magnets 134 are shown spaced apart from one another by equal angles in an inner circle. The magnets 132 of the outer circle may conveniently be located offset from the magnets 131 of the inner circle by 11.25°, as shown, so that with the front face 136 of the carrier 130 confronting the front face 108 of the supporting unit 106 there are 16 possible angular positions of the carrier 130 with respect to the supporting unit 106, and similarly with the rear face 138 of the carrier 138 confronting the front face 108 of the supporting unit 106 there are an additional 16 possible positions of rotation of the carrier 130, separated by 11.25° from the closest respective positions of rotation with the carrier 130 facing oppositely.

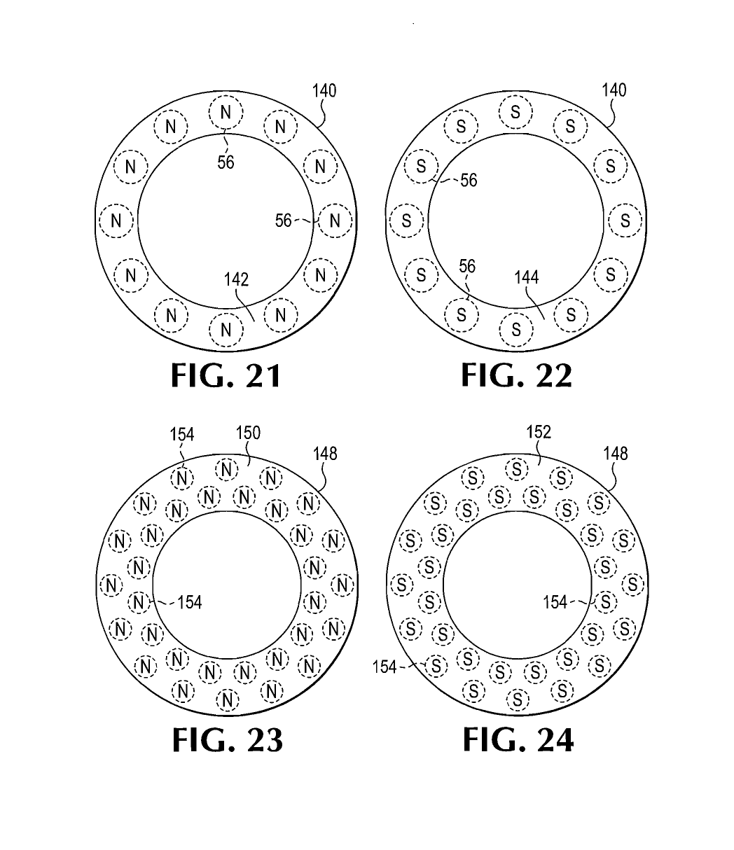

A carrier 140, shown somewhat schematically in FIGS. 21 and 22, is also of similar construction to that of the carrier 30, including twelve angularly equally spaced cavities in which magnets 56 are located. All of the magnets 56 are oriented in the same direction, with their north poles adjacent the front face 142 of the carrier 140 and thus with their south poles adjacent the rear face 144 of the carrier 140. Because all of the magnets 56 are oriented with the same polarity, the carrier 140 can be mounted on and attached to the front face 108 of the supporting unit 106 with the front face 142 of the carrier 140 confronting the front face 108 of the supporting unit 106, but will not be attracted to and held against the front face 108 if the rear face 144 of the carrier 140 is presented toward the front face 108 of the supporting unit 106. Thus there are twelve possible positions of rotation at which the carrier 140 can be attached to the supporting unit 106, but an optical element held within the carrier 140 will always be oriented in the same direction with respect to the optical axis of an optical system so long as the supporting unit 106 is kept oriented in the same direction with respect to the optical axis 40.

A carrier 148 shown somewhat schematically in FIGS. 23 and 24 may be similar to the carrier 130 shown in FIGS. 19 and 20. It has a front face 150 and a rear face 152 and may include cavities containing 32 magnets 154, similar to the magnets 132 and 134, arranged in two concentric circles. The magnets 154 may, as with the carrier 130, be spaced apart from one another by equal angles in each of the concentric circles, and the circles are staggered with respect to each other so that there is an equal angular separation of 11.25° between adjacent ones of 32 possible positions of rotation in which the carrier 148 can be mounted on and fastened to the supporting unit 106 with the front face 150 of the carrier 148 confronting the front face 108 of the supporting unit 106. As with the carrier 140, all of the magnets 154 are held with their poles oriented in the same direction, and so the orientation of the carrier 148 with respect to the optical axis 40 is not reversible so long as the supporting unit 106 on which it is mounted retains its orientation with respect to the optical axis 40 of an optical arrangement.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A mounting system for holding an optical element in a selected position, comprising:
(a) a supporting unit related to an optical system and included at a predetermined location with respect to an optical axis of an optical system;
(b) a pair of support magnetic elements each affixed to the supporting unit at a respective predetermined location thereon;
(c) a carrier adapted to hold an optical element in a predetermined position and orientation with respect to the carrier; and
(d) a pair of carrier magnetic elements affixed to said carrier at respective locations thereon, each such location corresponding to a respective one of the predetermined locations of the support magnetic elements, whereby the carrier magnetic elements can be aligned with the support magnetic elements with the carrier in a selected relationship to the supporting unit so that an optical element held in the carrier is thereby located in a selected position with respect to the optical axis and so that the carrier is attached to the supporting unit in a selected location with respect thereto.

2. The mounting system of claim 1, wherein the carrier magnetic elements affixed to the carrier member are arranged to hold the carrier selectively in each one of a plurality of available orientations with respect to the supporting unit.

3. The mounting system of claim 1, including a plurality of said carriers, wherein a carrier magnetic element is affixed to each of said carriers in a respective location corresponding with a location of another carrier magnetic element affixed to another one of said plurality of carriers and wherein respective ones of said plurality of carriers are attached to one another thereby.

4. The mounting system of claim 1 wherein the supporting unit is a camera body and said support magnetic elements are incorporated in said camera body so as to receive said carrier in said selected location.

5. The mounting system of claim 1 wherein a mating surface of the supporting unit and a mating surface of the carrier are planar and smooth.

6. The mounting system of claim 1 wherein the supporting unit has a receiving face and the carrier has a mating face shaped to fit closely against and in contact with the receiving face in any of a plurality of available positions and wherein the shapes of the receiving face and of the mating face cooperatively allow movement of the carrier with respect to the supporting member between adjacent ones of said plurality of available positions, while the receiving face and the mating face remain in contact with each other.

7. The mounting system of claim 6 wherein the receiving face of the supporting unit and the mating face of the carrier are planar.

8. The mounting system of claim 1 wherein said predetermined locations of said magnetic elements on said supporting unit are located on the supporting unit symmetrically with respect to the optical axis.

9. The mounting system of claim 1 wherein mutual magnetic attraction between the support magnetic elements and the carrier magnetic elements urge the carrier to move to and to remain in one of a plurality of available predetermined positions with respect to the supporting unit when the carrier is placed in proximity to the supporting unit.

10. The mounting system of claim 1 wherein the supporting member is a beam-profiling camera of an optical beam evaluation system.

11. The mounting system of claim 1 including a plurality of said carriers, at least a first one of said carriers having a pair of opposite sides, each of said opposite sides including a mating face, and wherein the carrier magnetic elements are located respectively in said first one of said carriers and a plurality of support magnetic elements are located in the supporting unit of the optical system so that said first one of said plurality of carriers can be attached to the supporting unit by mutual attraction between the carrier magnetic elements in said first one of said plurality of carriers and respective ones of the plurality of support magnetic elements, and respective carrier magnetic elements are located in another one of the plurality of carriers so that said other one of the plurality of carriers can be attached to the first one of the plurality of carriers by mutual magnetic attraction between respective carrier magnetic elements.

12. The mounting system of claim 1 wherein the supporting unit includes a plurality of support magnetic elements all oriented with like poles facing toward a mating surface.

13. The mounting system of claim 1 wherein the carrier has a mating face and a central axis oriented perpendicular to the mating face and wherein the carrier holds an optical element having an optical axis with the optical axis of the optical element oriented at a predetermined pointing angle of divergence from said central axis of the carrier, the central axis of the carrier and the optical axis of the optical element jointly defining a plane located at a predetermined position angle of rotation about the central axis of the carrier.

14. The mounting system of claim 13 wherein the carrier includes indicia identifying the position angle.

15. The mounting system of claim 13 wherein the carrier is color coded to identify a pointing angle established by the carrier for an optical element held by the carrier.

16. The mounting system of claim 13 wherein the carrier is color coded to identify a position angle established by the carrier for an optical element held by the carrier.

17. The mounting system of claim 1 wherein the carrier has a pair of opposite sides and the carrier magnetic elements are affixed to the carrier in respective positions in which magnetic attraction between respective ones of the carrier magnetic elements and respective ones of the support magnetic elements holds the carrier mounted on the supporting unit in a position of alignment therewith regardless of which of the opposite sides of the carrier is facing toward the supporting unit.

18. The mounting system of claim 1 wherein the supporting unit has a front side and a back side and at least one said pair of support magnetic elements is located closely enough to each of said front side and said back side of the supporting unit that the at least one pair of support magnetic elements are able to support said carrier, with each support magnetic element of each said pair affixed to the supporting unit at a respective predetermined location thereon.
